(19) United States
(12) Patent Application Publication
(10) Pub. No.: US 2014/0335794 A1
(43) Pub. Date: Nov. 13, 2014

(54) System and Method for Automated Testing of Mobile Computing Devices

(71) Applicant: Eddie Forouzan, San Diego, CA (US)

(72) Inventor: Eddie Forouzan, San Diego, CA (US)

(21) Appl. No.: 14/273,464

(22) Filed: May 8, 2014

Related U.S. Application Data
(60) Provisional application No. 61/821,180, filed on May 8, 2013.

(51) Int. Cl. H04M 3/24

(52) U.S. Cl. CPC H04M 3/24
USPC 455/67.11

(57) ABSTRACT

Methods and systems are disclosed that determine a device's operational characteristics, and then self-adjusts to the device's capabilities. Operational characteristics of the device can provide use cases, which can include, without limitation, voice calls, email (push or manual), Bluetooth, WiFi, WiMax or other near-range or midrange wireless protocol communication (synchronized, idle or active), video or audio playback (streaming over a network or local from a local memory store), Global Positioning System (GPS) communication, web browsing, short messaging service (SMS), camera (image acquisition, manipulation, editing and storage), and other use cases.

### REFERENCE TO PRIORITY DOCUMENT

This application claims the benefit of priority under 35 U.S.C. §119(e) of U.S. Provisional Patent Application Ser. No. 61/821,180, filed May 8, 2013 under 37 C.F.R. §1.78(a). Priority of the filing date is hereby claimed and the full disclosure of the aforementioned application is incorporated herein by reference.

### TECHNICAL FIELD

The subject matter described herein relates to testing platforms, and more particularly to a system and method for automated and adaptive testing of mobile computing devices.

### BACKGROUND

Mobile computing devices can include phones, tablet computers, and even laptop or notebook computers. Mobile computing devices, as that term is used herein, can include one or more processors running an operating system, and which execute one or more application programs locally on the device. Example operating systems include iOS for Apple iPhones and iPads, Android for Android-compatible mobile computing devices, Windows Mobile, and Blackberry operating systems. These operating systems and the mobile computing devices that run them are sometimes referred to as “smartphones.”

Mobile computing devices typically include one or more status indicators, such as battery life remaining. These status indicators are usually determined in a test or testing environment prior to the mobile computing device actually being used by a user. Sometimes, the test or testing environment looks only at estimated or theoretical device capabilities, or is based on simulations, extrapolations, etc. Further, these tests are not adaptable, e.g., do not adjust to options and limitations of any specific device or use case.

Extrapolations or simulations result in significant error for the status indicators. For example, existing battery runtime determination approaches result in significant errors. They typically rely on taking a snapshot of the power consumed, and on mathematically normalizing the measurement to the “rated” battery capacity. Further, battery manufacturers do not disclose actual battery ratings. They typically publish a “typical” or “minimum” capacity rating. Mathematically normalizing to these published values result in considerable errors.

### SUMMARY

In one aspect, a method and system are disclosed, which take advantage of the actual capabilities of the device under test (DUT), using real-time and real-life measurements of the DUT, and not simulations or extrapolations. The method and system provide an adaptive testing process, which adjusts itself to the options and limitations of the DUT, and which produce results that are accurate and reproducible.

In some aspects, a system and method for testing a mobile device is disclosed. A set of operational features of a mobile computing device is determined. Then, a set of operational characteristics for the mobile computing device is determined, where the set of operational characteristics is based on the set of operational features. A test process is then automatically executed to operate each of the operational features for the set of operational features. Result data of each of the operational features is recorded, and a result profile is generated for the mobile computing device. The result profile is based on a comparison of the result data of each of the operational features and the set of operational characteristics for the mobile computing device.

Some method implementations can include determining, by one or more processors, a set of operational features of a mobile computing device and determining, by the one or more processors, a set of operational characteristics for the mobile computing device with the set of operational characteristics being based on the set of operational features. In addition, the method can include executing, by the one or more processors, a test process to operate each of the operational features for the set of operational features and recording, by the one or more processors, result data of each of the operational features. Additionally, the method can include generating, by the one or more processors, a result profile for the mobile computing device, the result profile being based on a comparison of the result data of each of the operational features and the set of operational characteristics for the mobile computing device.

Implementations of the current subject matter can include, but are not limited to, systems and methods. In addition, one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a functional block diagram illustrating a test system executing a test method of a DUT;

FIGS. 2A-2K are flowcharts of a process flow of a testing environment and testing method in accordance with implementations described herein.

FIG. 3 illustrates a graph of data acquired by the test system in a call and pause of a DUT.

FIG. 4 illustrates a graph of data acquired by the test system for music play, pause, call, and charge on a DUT.

When practical, similar reference numbers denote similar structures, features, or elements.

### DETAILED DESCRIPTION

To address these and potentially other issues with currently available solutions, methods, systems, articles of manufacture, and the like consistent with one or more implementations of the current subject matter can, among other possible advantages, provide a testing environment for mobile computing devices that results in reproducible and accurate data, generates real data off of real devices, and avoids significant technician involvement and intervention. Using the method and system disclosed herein, there is no need for very expensive test equipment. The method and system can be used universally on any device and does not need to be tailored to a specific device's technology and capabilities, and allows for a uniform testing process amongst various entities (e.g., manufacturers and test labs).

A method and system in accordance with preferred exemplary implementations, determines the device's operational characteristics, and then self-adjusts to the device's capabilities. Operational characteristics of the device provide use cases, which can include, without limitation, voice calls, email (push or manual), Bluetooth, WiFi, WiMax or other near-range or midrange wireless protocol communication (synchronized, idle or active), video or audio playback (streaming over a network or local from a local memory store), Global Positioning System (GPS) communication, web browsing, short messaging service (SMS), camera (image acquisition, manipulation, editing and storage), and other use cases.

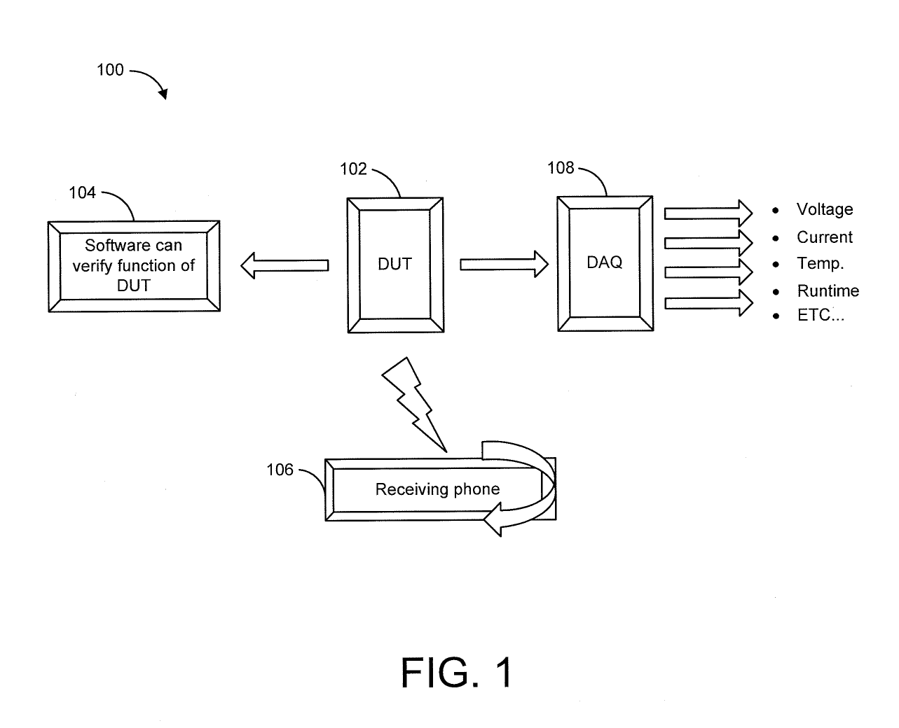

FIG. 1 is a functional block diagram illustrating a test system 100 executing a test method of a DUT 102. The test system 100 includes verification software 104 to verify the functions of the DUT described above with respect to the use cases. The verification software 104 can be an application on the DUT 102 itself, or may be resident on an external computer or server and in communication with the DUT 102 via a communication link or communication channel. The verification software 104 includes any number of modules to verify the functions that are currently being executed by the DUT 102 under any of a number of use cases or use scenarios.

The use scenarios include communication with a receiving phone 106 or other receiving computing device, such as a mobile phone, a server, a client computer, or any other type of computing device.

The test system further includes a data acquisition module 108, which can be a processor or computer or the like, or any device capable of receiving and acquiring data from the DUT 102. The data acquisition module 108 monitors, records, acquires and/or stores data representative of various characteristics of the DUT including, without limitation, voltage, current, temperature, runtime, etc., of any part or functional or operational component of the DUT. For example, the data acquisition module 108 may monitor temperature and voltage at a processor that produces a display in the DUT 102, while also monitoring a current supplied to, or being drawn from, a battery of the DUT 102. Any type of data, from any number of functional or operational hardware, software, or firmware, can be acquired by the data acquisition module 108. This means that accuracy will not be affected by acquisition rate, because it is not necessary to integrate the data over time.

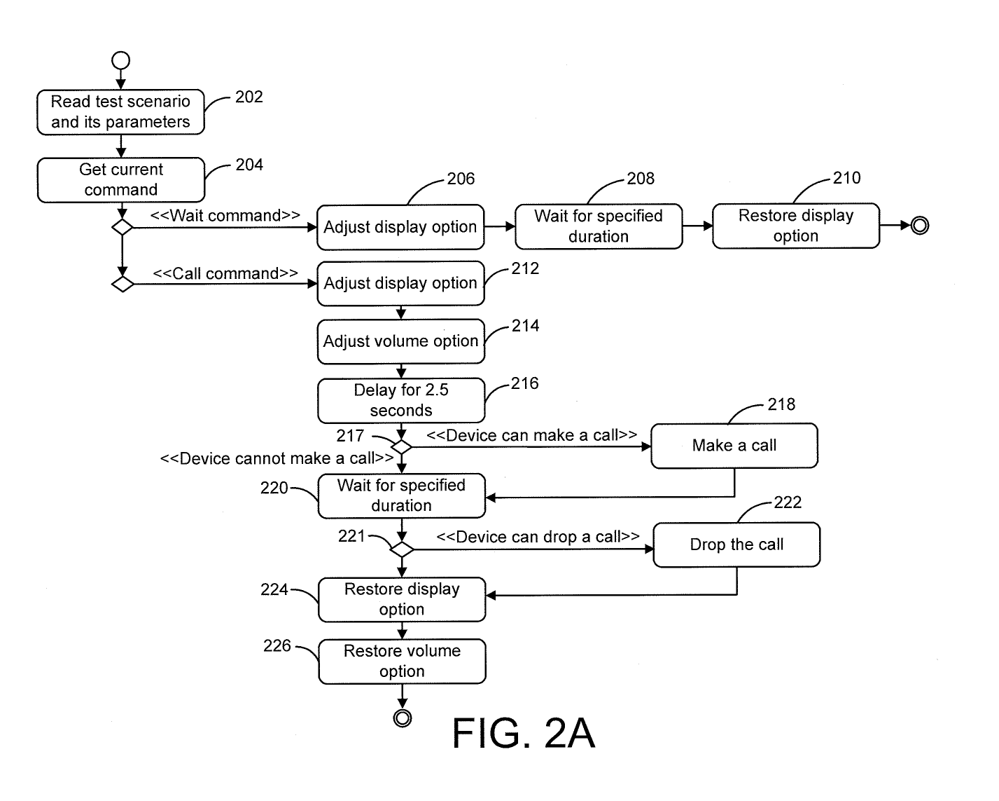

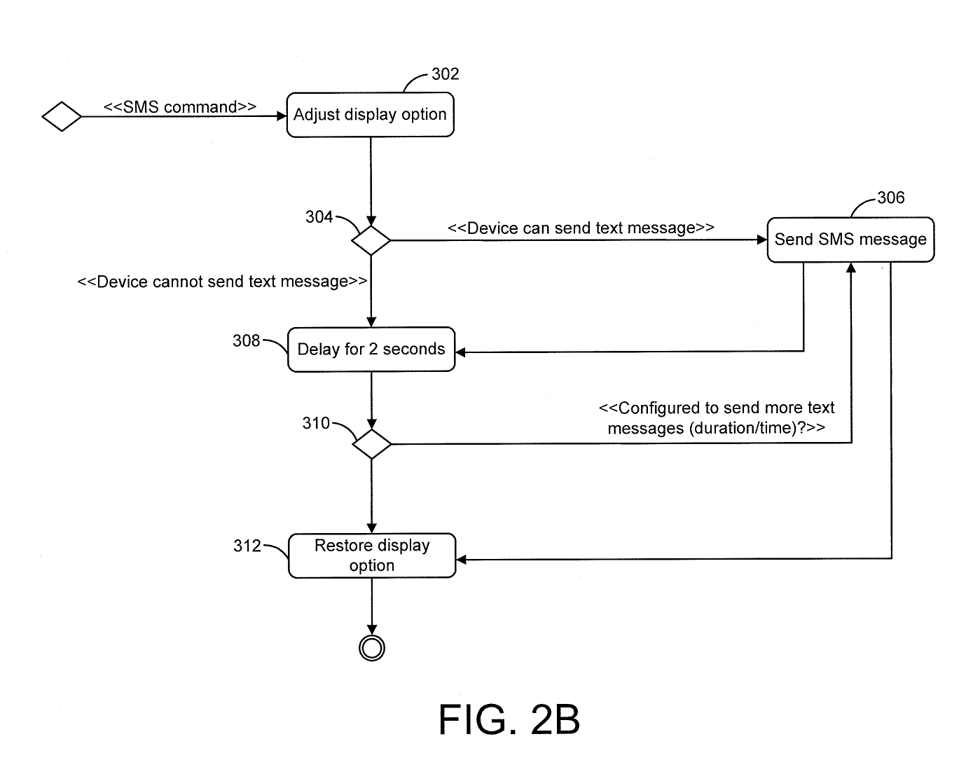

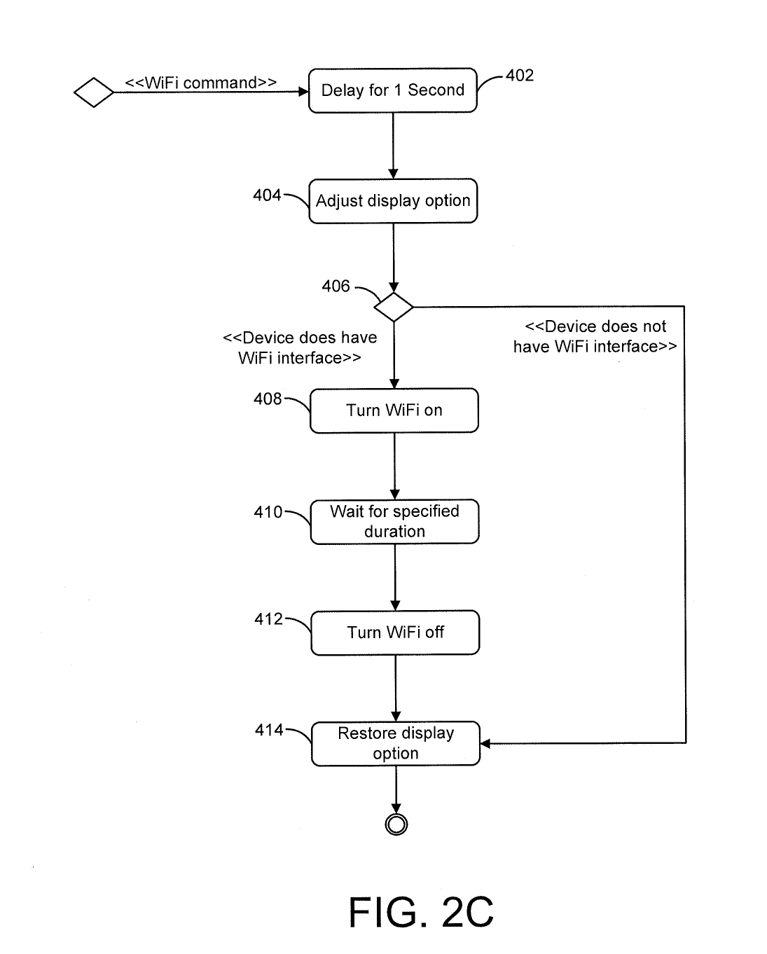

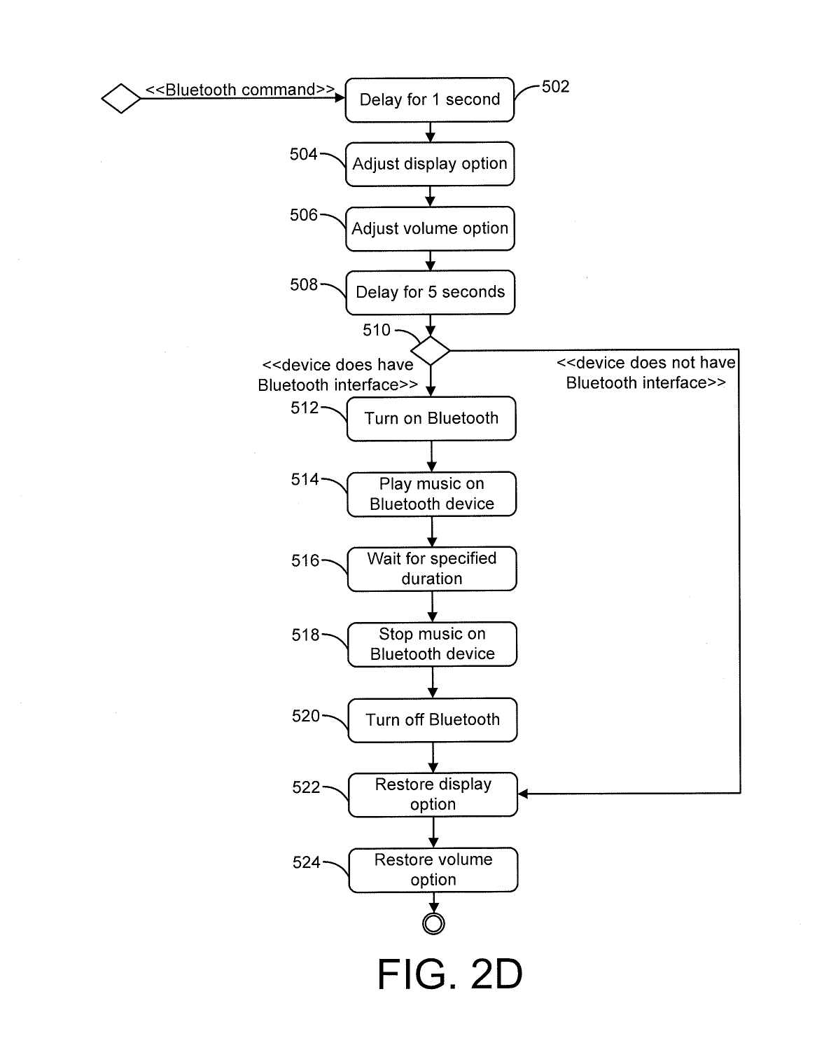

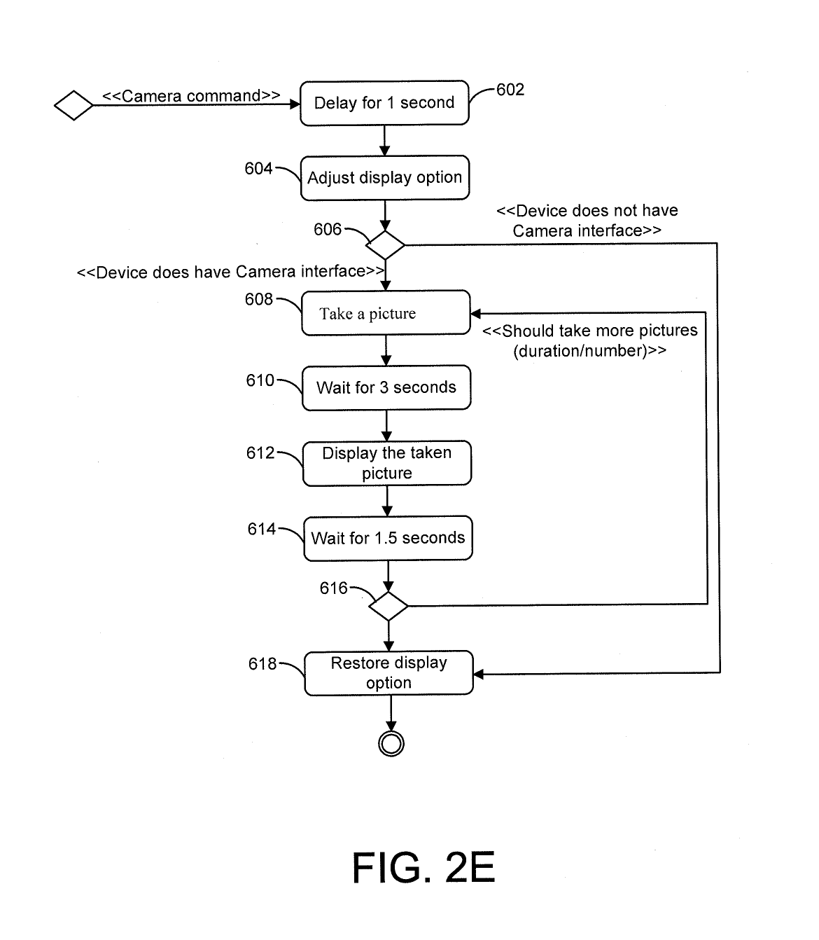

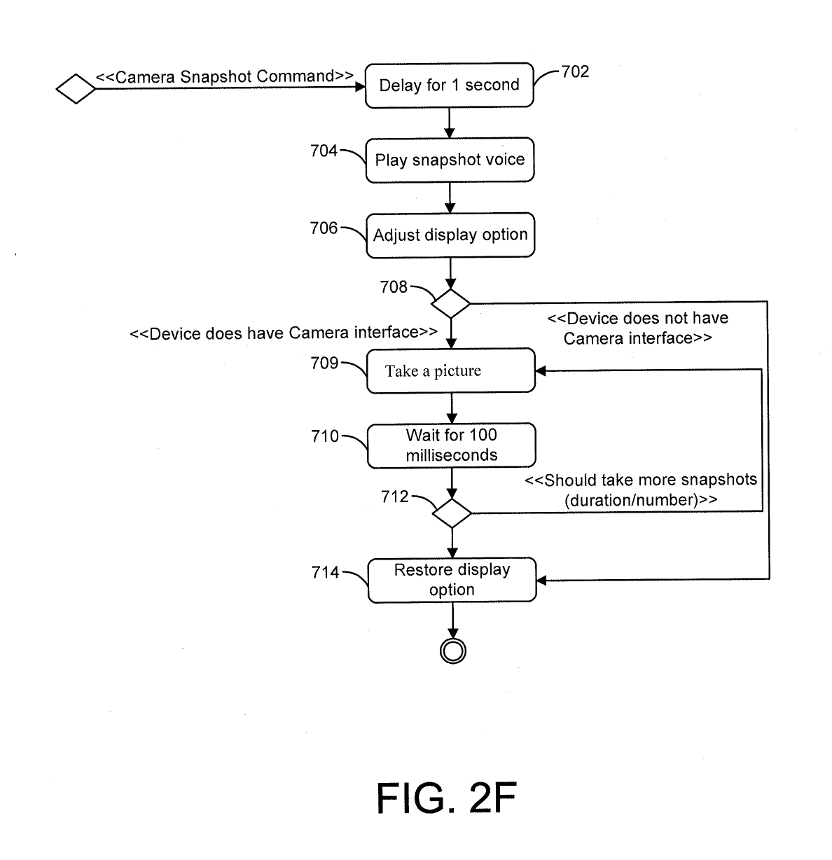

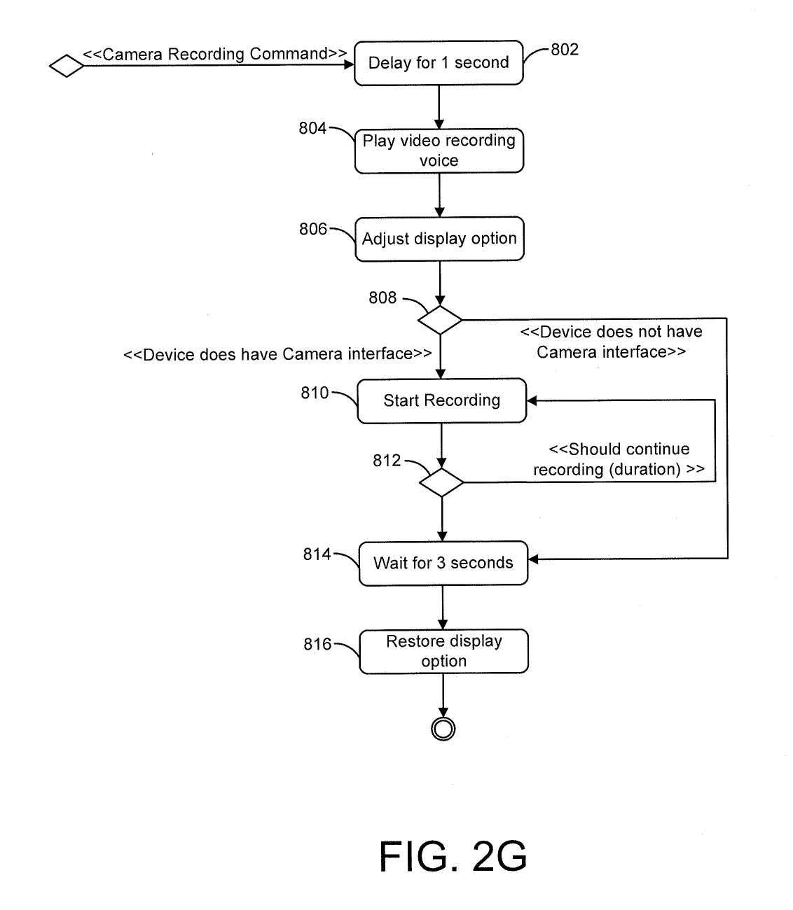

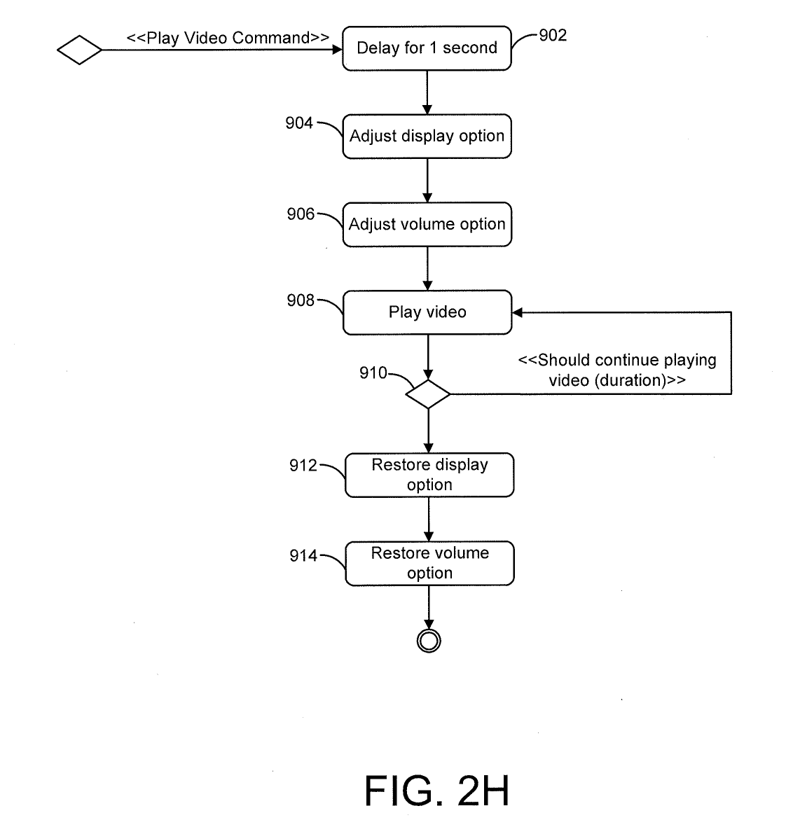

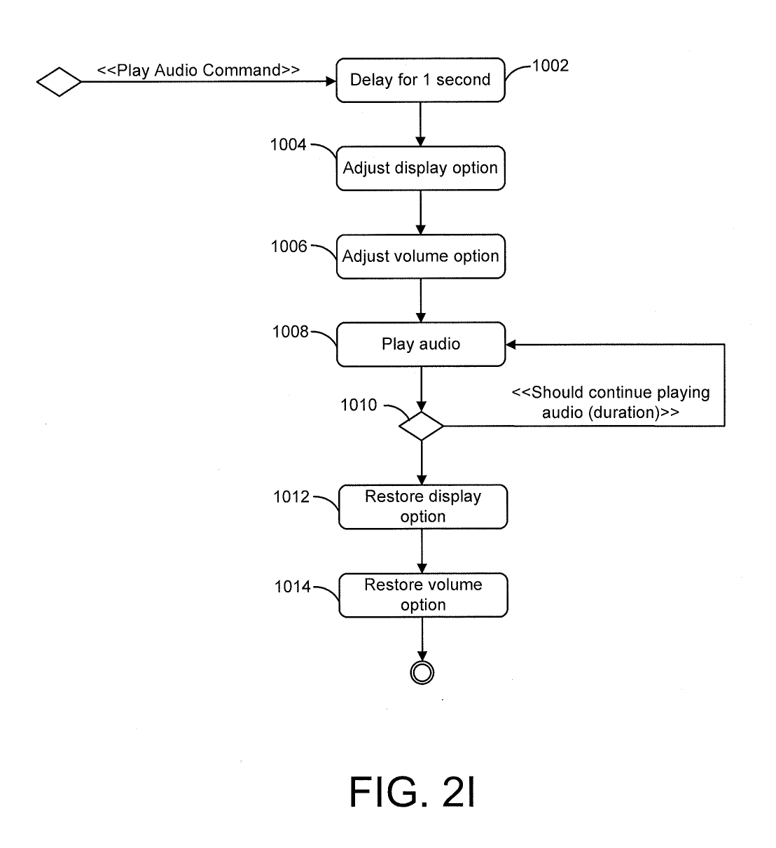

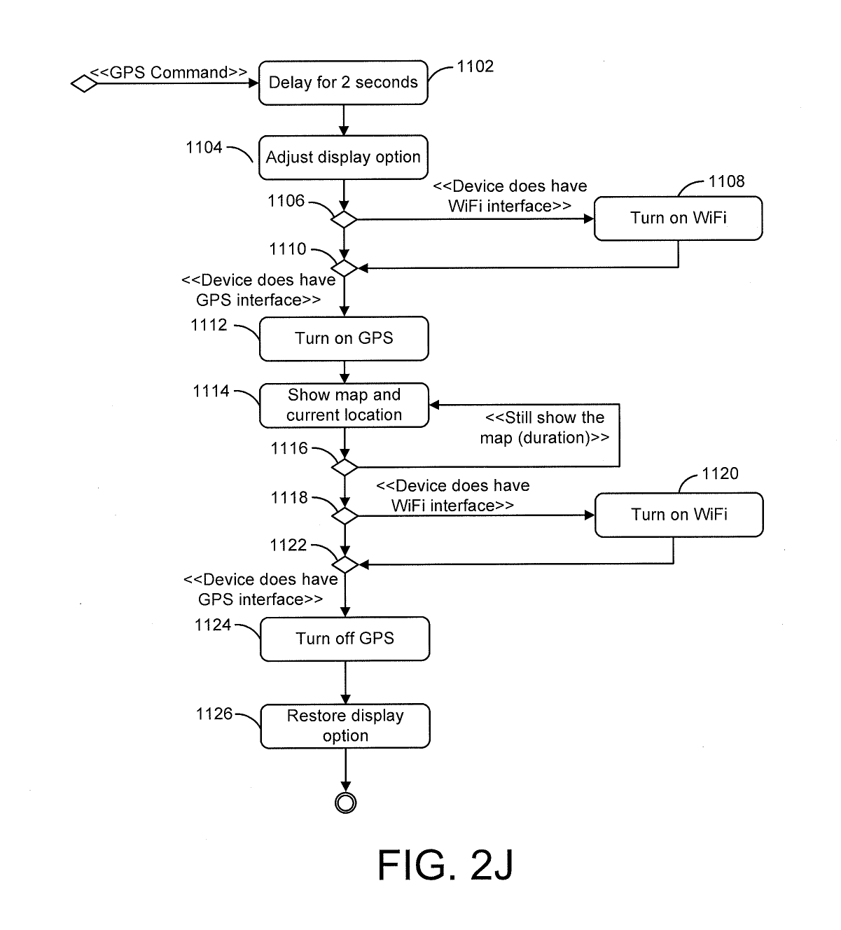

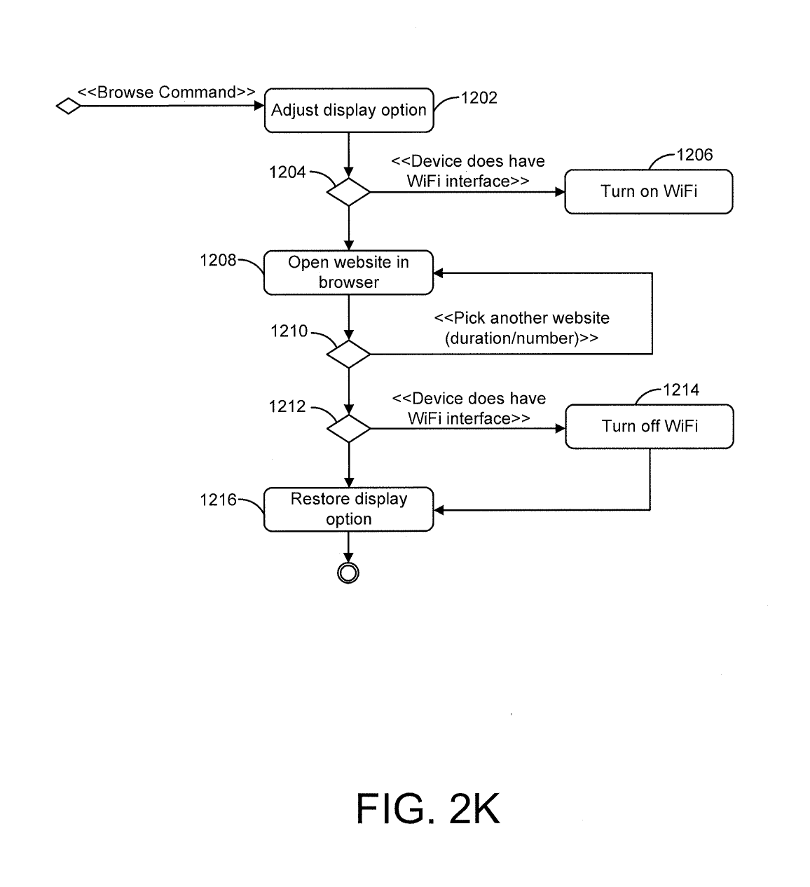

FIGS. 2A-2K are flowcharts of sub-processes of a process flow of a testing environment and testing method for testing various functions, features and other operational characteristics of a device. The sub-processes can be modular, and can be executed in any combination, order, sequence, etc. Any one sub-process may or may not be dependent on any other sub-process. Execution of each sub-process can be configured by a user, or may be configured automatically based on the functions, features or other operational characteristics of a device under test (DUT).

A testing environment includes a testing computer for testing a device. As shown in FIG. 2A, at 202 a test scenario and the test scenarios parameters are read by the testing computer. The test scenario can be any functional or operational procedure to test the device, and the parameters can include a time, a power level, a measurement of an input, a measurement of an output, or the like. The parameters can include any quantification of any aspect by which the test scenario is executed, or for which results are sought to be determined. At 204, a current command for a particular test scenario is obtained by the testing computer.

To test a “wait command,” at 206, the testing computer adjusts a display option for the DUT, at 208 the testing computer waits for a specified duration (as specified by the parameters of the test scenario), and at 210 the testing computer restores the display option for the DUT. To test a “call command,” at 212 the testing computer adjusts a display option for the DUT, and at 214 the testing computer adjusts a volume option of the DUT. At 216, the testing computer invokes a delay for a specified period of time, such as, for example, approximately within a range of two to three seconds. The delay can be more or less than approximately two or three seconds, however, and after the delay, at 217, the testing computer determines whether the DUT can make a call. If the DUT can make a call, at 218 the testing computer enables the DUT to make the call. If the DUT cannot make the call, or after the call is made at 218, at 220 the testing computer waits another specified duration.

At 221, the testing computer determines whether the DUT can drop a call. If the DUT can drop a call, at 222 the testing computer enables the DUT to drop the call. If the DUT cannot drop the call, or after the call is dropped at 222, at 224 the testing computer restores the display option that was adjusted at 212, and at 226 the testing computer restores the volume option that was adjusted at 214.

As shown in FIG. 2B, to test a “SMS command,” at 302, the testing computer adjusts the display option for the DUT. At 304, the testing computer determines whether the DUT can send a text message, or SMS message. If the DUT can send a text message, at 306 the testing computer enables the DUT to send a text message. If the DUT cannot send a text message, or after the text message is sent at 306, at 308 the testing computer waits a specified duration, such as, for example, approximately two seconds.

At 310, the testing computer determines whether the DUT is configured to send more text messages. If the DUT is configured to send more text messages, at 306 the testing computer enables the DUT to send more text messages. In addition, the testing computer can enable the DUT to send more messages for an additional period of time. For example, the DUT can send text messages for approximately one additional minute. If the DUT is not configured to send more text messages, or after no more text messages are sent, at 312 the testing computer restores the display option that was adjusted at 302.

As shown in FIG. 2C, to test a “Wi-Fi command,” at 402, the testing computer invokes a delay for a specified period of time, such as, for example, approximately one second. The delay can be more or less than one second, however, and after the delay, at 404, the testing computer adjusts the display option for the DUT.

At 406, the testing computer determines whether the DUT has a Wi-Fi interface. If the DUT has a Wi-Fi interface, at 408, the testing computer enables the DUT to turn the Wi-Fi on. After the testing computer enables the DUT to turn the Wi-Fi on, at 410, the testing computer invokes a delay for a specified period of time and then, at 412, the testing computer enables the DUT to turn the Wi-Fi off. If the DUT does not have Wi-Fi interface, or after the Wi-Fi is turned off at 412, at 414 the testing computer restores the display option that was adjusted at 404.

As shown in FIG. 2D, to test a “Bluetooth command,” at 502, the testing computer invokes a delay for a specified period of time, such as, for example, approximately one second. The delay can be more or less than one second, however, and after the delay, at 504, the testing computer can adjust the display option for the DUT. At 506, the testing computer adjusts the volume option of the DUT and, at 508, the testing computer invokes another delay for a specified period of time, such as, for example, approximately five seconds.

At 510, the testing computer determines whether the DUT has Bluetooth interface. If the DUT has Bluetooth interface, at 512 the testing computer enables the DUT to turn on the Bluetooth. After the testing computer enables the DUT to turn on the Bluetooth, at 514, the testing computer enables the DUT to play music on the Bluetooth device. Then, at 516, the testing computer invokes a waiting period, or delay, for a specified duration. Following the waiting period, at 518, the testing computer enables the DUT to stop playing music on the Bluetooth device and, at 520, the testing computer enables the DUT to turn off the Bluetooth. If the DUT does not have Bluetooth interface, or after the Bluetooth is turned off at 522, at 524 the testing computer restores the volume option that was adjusted at 506.

As shown in FIG. 2E, to test a “camera command,” at 602, the testing computer invokes a delay for a specified period of time, such as, for example, approximately one second. The delay can be more or less than one second, however, and after the delay, at 604, the testing computer can adjust the display option for the DUT.

At 606, the testing computer determines whether the DUT has a camera interface. If the DUT has a camera interface, at 608 the testing computer enables the DUT to take a picture. After the testing computer enables the DUT to take a picture, at 610, the testing computer invokes a waiting period, or delay, for a specified period of time, such as, for example, approximately three seconds. The delay can be more or less than three seconds, however, and after the delay, at 612, the testing computer enables the DUT to display the picture that was taken. Then, at 614, the testing computer invokes another waiting period, or delay, for a specified duration, such as, for example, 1.5 seconds.

At 616, the testing computer determines whether more pictures should be taken. In addition, the testing computer can enable the DUT to take more pictures for an additional period of time. For example, the DUT can take pictures for approximately one additional minute. If the DUT determines that more pictures should be taken, then, at 608, another picture is taken. If the DUT does not have a camera interface, or no more pictures are chosen to be taken at 616, at 618 the testing computer restores the display option that was adjusted at 604.

As shown in FIG. 2F, to test a “camera snapshot command,” at 702, the testing computer invokes a delay for a specified period of time, such as, for example, approximately one second. The delay can be more or less than one second, however, and after the delay, at 704, the testing computer enables the DUT to play a snapshot voice and, at 706, the testing computer adjusts a display option for the DUT.

At, 708 the testing computer determines whether the DUT has a camera interface. If the DUT has a camera interface, at 709 the testing computer enables the DUT to take a picture. After the testing computer enables the DUT to take a picture, at 710, the testing computer invokes a waiting period, or delay, for a specified period of time, such as, for example, approximately 100 milliseconds. The delay can be more or less than 100 milliseconds, however, and after the delay, at 712, the testing computer determines whether more snapshots should be taken. In addition, the testing computer can enable the DUT to take additional snapshots for an additional period of time. For example, the DUT can take additional snapshots for approximately one additional minute. If the testing computer determines that more snapshots should be taken, then, at 709, another picture is taken. If the DUT does not have a camera interface, or no more snapshots are chosen to be taken at 712, at 714 the testing computer restores the display option that was adjusted at 706.

As shown in FIG. 2G, to test a “camera recording command,” at 802, the testing computer invokes a delay for a specified period of time, such as, for example, approximately one second. The delay can be more or less than one second, however, and after the delay, at 804, the testing computer can enable the DUT to play a recording voice. Then, at 806, the testing computer adjusts a display option for the DUT.

At, 808 the testing computer determines whether the DUT has a camera interface. If the DUT has a camera interface, at 810 the testing computer enables the DUT to start recording. After the testing computer enables the DUT to start recording, at 812, the testing computer determines whether recording should continue. In addition, the testing computer can enable the DUT to record for an additional period of time. For example, the DUT can record for approximately one additional minute. If the testing computer determines that recording should continue, then recording continues at 810. If the DUT does not have a camera interface, or the testing computer determines that recording should stop at 812, then at 814 the testing computer invokes a delay for a specified period of time, such as, for example, approximately three seconds. The delay can be more or less than three seconds, however, and after the delay, at 816, the testing computer can restore the display option that was adjusted at 806.

As shown in FIG. 2H, to test a “play video command,” at 902, the testing computer invokes a delay for a specified period of time, such as, for example, approximately one second. The delay can be more or less than one second, however, and after the delay, at 904, the testing computer can adjust a display option for the DUT. Then, at 906, the testing computer can adjust the volume option for the DUT and, at 908, the testing computer can enable the DUT to play a video.

At 910, the testing computer determines whether the video should continue playing. In addition, the testing computer can enable the DUT to play video for an additional period of time. For example, the DUT can play video for approximately one additional minute. If the testing computer determines that recording should continue then the video continues to play at 908. If the testing computer determines that recording should stop at 910, at 912 the testing computer can restore the display option that was adjusted at 904 and, at 914, the testing computer can restore the volume option that was adjusted at 906.

As shown in FIG. 2I, to test a “play audio command,” at 1002, the testing computer invokes a delay for a specified period of time, such as, for example, approximately one second. The delay can be more or less than one second, however, and after the delay, at 1004, the testing computer can adjusts a display option for the DUT. Then, at 1006, the testing computer can adjust the volume option for the DUT and, at 908, the testing computer can enable the DUT to play audio.

At 1010, the testing computer determines whether the DUT should continue playing audio. In addition, the testing computer can enable the DUT to play audio for an additional period of time. For example, the DUT can play audio for approximately one additional minute. If the DUT should continue to play audio then the testing computer enables the DUT to continue to play audio at 1008. If the testing computer determines that the DUT should not continue playing audio at 1010, at 1012 the testing computer can restore the display option that was adjusted at 1004 and, at 1014, the testing computer can restore the volume option that was adjusted at 1006.

As shown in FIG. 2J, to test a “GPS command,” at 1102, the testing computer invokes a delay for a specified period of time, such as, for example, approximately two seconds. The delay can be more or less than two seconds, however, and after the delay, at 1104, the testing computer can adjusts a display option for the DUT.

At 1106, the testing computer determines whether the DUT has Wi-Fi interface. If the DUT has Wi-Fi interface, at 1108 the testing computer enables the DUT to turn on the Wi-Fi. If it is determined that the DUT does not have Wi-Fi or after the Wi-Fi is turned on, at 1110 the testing computer determines if the DUT has a GPS interface and turns on the GPS at 1112. After the GPS is turned on, at 1114 the testing computer enables the DUT to show a map and current location and, at 1116, the testing computer determines again whether the DUT has Wi-Fi interface. If the DUT has Wi-Fi interface, at 1120 the testing computer enables the DUT to turn off the Wi-Fi. If it is determined that the DUT does not have a Wi-Fi interface or after the Wi-Fi is turned off, at 1122 the testing computer determines if the DUT has a GPS interface and turns off the GPS at 1124. Then, at 1126, the testing computer restores the display option that was adjusted at 1104.

As shown in FIG. 2K, to test a “browse command,” at 1202, the testing computer adjusts a display option for the DUT. Then, at 1204, the testing computer determines whether the DUT has a Wi-Fi interface. If the DUT has a Wi-Fi interface, at 1206 the testing computer enables the DUT to turn on the Wi-Fi. If it is determined that the DUT does not have a Wi-Fi interface or after the Wi-Fi is turned on, at 1208 the testing computer opens a website in a browser. Then, at 1210, the testing computer determines whether the DUT should pick another website. In addition, the testing computer can enable the DUT to cycle through web sites for an additional period of time. For example, the DUT can cycle through web sites for approximately one additional minute, or cycle through a set number of web sites (e.g., 20 web sites). If it is determined that another website should be chosen, the testing computer enables the DUT to pick another website and, at 1208, the website is opened in a browser.

If another website is not chosen at 1210, at 1212 the testing computer determines whether the DUT has a Wi-Fi interface. If the DUT has a Wi-Fi interface, at 1214 the testing computer enables the DUT to turn off the Wi-Fi. If it is determined that the DUT does not have a Wi-Fi interface or after the Wi-Fi is turned off, at 1216 the testing computer restores the display option that was adjusted at 1202.

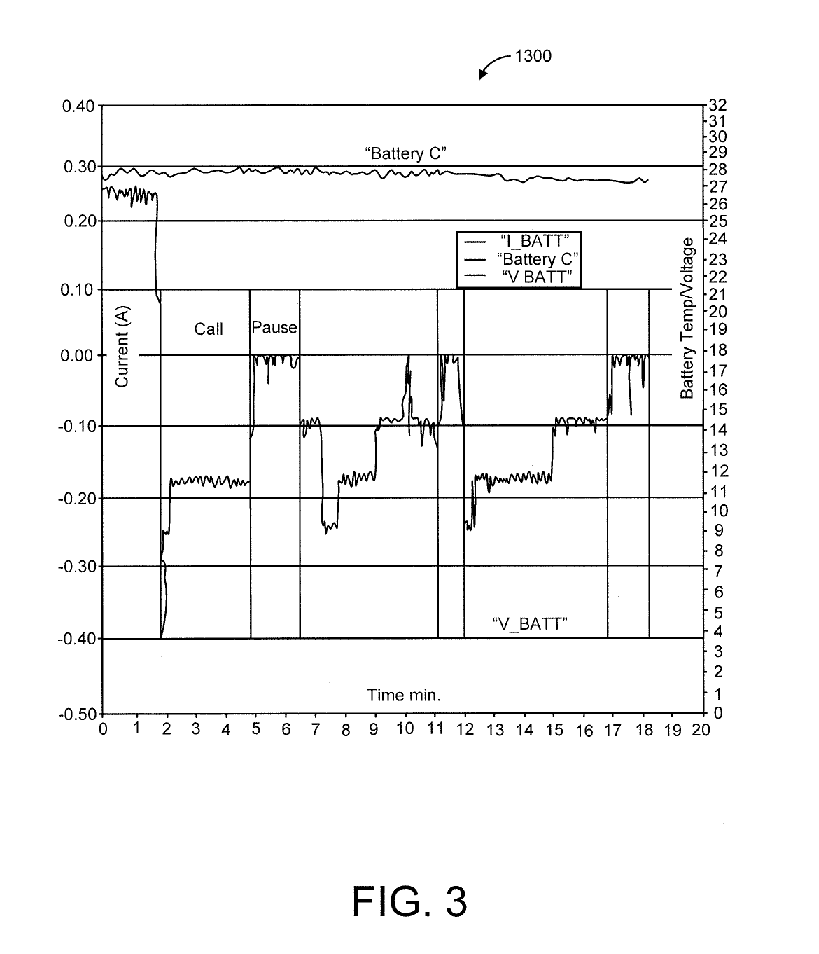

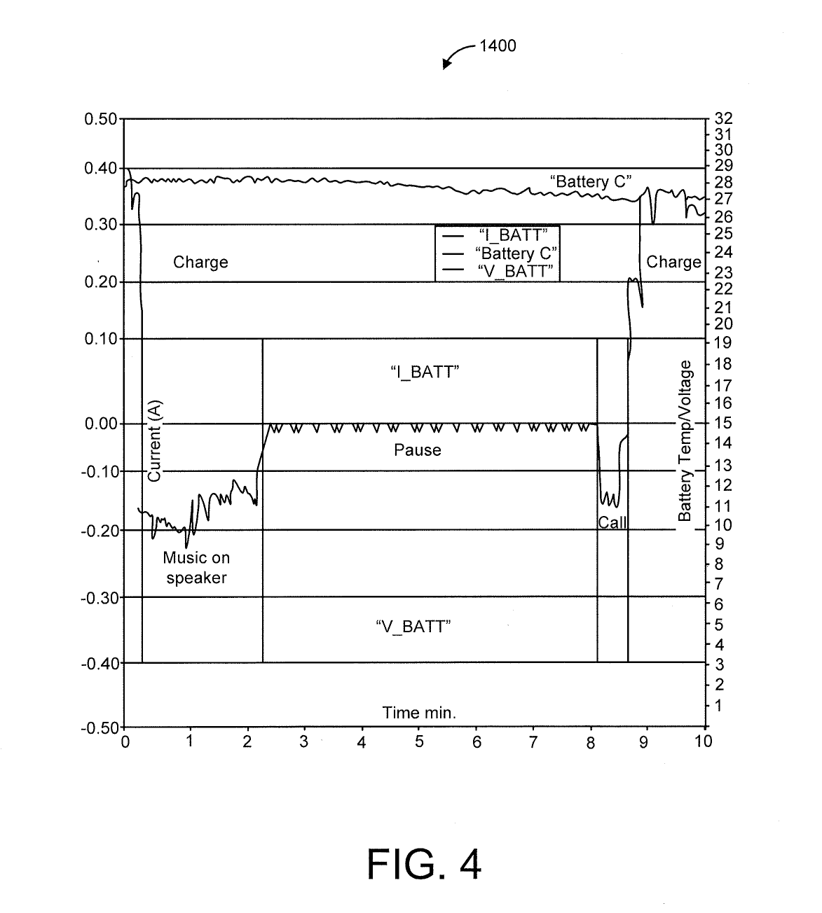

FIG. 3 illustrates a graph of data 1300 acquired by the test system in a call and pause of a DUT, in this case a cell phone. The graph of data provides a measurement of current against time for a battery during the call and pause of the DUT. FIG. 4 illustrates a graph of data 1400 acquired by the test system for music play, pause, call, and charge on a DUT, in this case a digital media player device. Using such a specific software approach for each individual device, the test system can provide very accurate information for status indicators or other metrics for the device.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising;
determining, by one or more processors, a set of operational features of a mobile computing device;
determining, by the one or more processors, a set of operational characteristics for the mobile computing device, the set of operational characteristics being based on the set of operational features;
executing, by the one or more processors, a test process to operate each of the operational features for the set of operational features;
recording, by the one or more processors, result data of each of the operational features; and
generating, by the one or more processors, a result profile for the mobile computing device, the result profile being based on a comparison of the result data of each of the operational features and the set of operational characteristics for the mobile computing device.

2. The method in accordance with claim 1, wherein the set of operational features is selected from the group of operational features consisting of: voice calls, email, Bluetooth, WiFi, WiMax or other near-range or midrange wireless protocol communication, video or audio playback, Global Positioning System (GPS) communication, web browsing, short messaging service (SMS), camera image acquisition, camera manipulation, image editing, and image storage.

3. The method in accordance with claim 1, further comprising
adapting, by the one or more processors, the test process to the set of operational features determined for the mobile computing device, the adapting comprising eliminating a test sub-process for an operation that cannot be executed by the mobile computing device.

4. A computer program product comprising a machine-readable medium storing instructions that, when executed by at least one programmable processor, cause the at least one programmable processor to perform operations comprising:
determining a set of operational features of a mobile computing device;
determining a set of operational characteristics for the mobile computing device, the set of operational characteristics being based on the set of operational features;
executing a test process to operate each of the operational features for the set of operational features;
recording result data of each of the operational features; and
generating a result profile for the mobile computing device, the result profile being based on a comparison of the result data of each of the operational features and the set of operational characteristics for the mobile computing device.

5. The computer program product in accordance with claim 4, wherein the set of operational features is selected from the group of operational features consisting of: voice calls, email, Bluetooth, WiFi, WiMax or other near-range or midrange wireless protocol communication, video or audio playback, Global Positioning System (GPS) communication, web browsing, short messaging service (SMS), camera image acquisition, camera manipulation, image editing, and image storage.

6. The computer program product in accordance with claim 4, wherein the operations further comprise adapting the test process to the set of operational features determined for the mobile computing device, the adapting comprising eliminating a test sub-process for an operation that cannot be executed by the mobile computing device.

7. A system comprising:
at least one programmable processor; and
a machine-readable medium storing instructions that, when executed by the at least one processor, cause the at least one programmable processor to perform operations comprising:
determining a set of operational features of a mobile computing device;
determining a set of operational characteristics for the mobile computing device, the set of operational characteristics being based on the set of operational features;
executing a test process to operate each of the operational features for the set of operational features;
recording result data of each of the operational features; and
generating a result profile for the mobile computing device, the result profile being based on a comparison of the result data of each of the operational features and the set of operational characteristics for the mobile computing device.

8. The system in accordance with claim 7, wherein the set of operational features is selected from the group of operational features consisting of: voice calls, email, Bluetooth, WiFi, WiMax or other near-range or midrange wireless protocol communication, video or audio playback, Global Positioning System (GPS) communication, web browsing, short messaging service (SMS), camera image acquisition, camera manipulation, image editing, and image storage.

9. The system in accordance with claim 7, wherein the operations further comprise adapting the test process to the set of operational features determined for the mobile computing device, the adapting comprising eliminating a test sub-process for an operation that cannot be executed by the mobile computing device.
